(19) United States
(12) Patent Application Publication
(10) Pub. No.: US 2018/0084237 A1
(43) Pub. Date: Mar. 22, 2018

(54) 3-DIMENSIONAL (3D) CONTENT PROVIDING SYSTEM, 3D CONTENT PROVIDING METHOD, AND COMPUTER-READABLE RECORDING MEDIUM

(71) Applicant: VIEWIDEA CO., LTD., Seoul (KR)

(72) Inventor: Ha Dong KIM, Paju-si (KR)

(21) Appl. No.: 15/333,989

(22) Filed: Oct. 25, 2016

(30) Foreign Application Priority Data
Sep. 21, 2016 (KR) 10-2016-0120754

(51) Int. Cl. H04N 13/02; H04N 13/00; H04N 13/04

(52) U.S. Cl. CPC H04N 13/026; H04N 2013/0077; H04N 13/0456; H04N 13/0037

(57) ABSTRACT

A three-dimensional (3D) content providing system, a 3D content providing method, and a non-transitory computer-readable recording medium are provided. The 3D content providing system includes an imaging unit configured to acquire a two-dimensional (2D) image, an image conversion unit configured to extract a rectangular region that surrounds the 2D image acquired by the imaging unit, and to perform image warping with respect to the extracted rectangular region to thereby generate a 3D image corresponding to the 2D image, and a display unit configured to output the 3D image.

### CROSS-REFERENCE TO RELATED APPLICATION

This application claims the benefit of priority of Korean Patent Application No. 10-2016-0120754, filed on Sep. 21, 2016, in the Korean Intellectual Property Office, the disclosure of which is incorporated herein in its entirety by reference.

### BACKGROUND

### 1. Field

One or more embodiments relate to systems and methods for providing three-dimensional (3D) content and non-transitory computer-readable recording media, and more particularly, to a 3D content providing system, a 3D content providing method, and a computer-readable recording medium, by which, when a 3D image is generated from a user-participating 2D image, color information of the 2D image is extracted and reflected in the 3D image, and 3D image object is applicable to various platforms.

### 2. Description of the Related Art

Interest in virtual reality and augmented reality is increasing with developments in information technology (IT), and provision of experiences similar to reality has been attempted.

Virtual reality and augmented reality are being evaluated as technologies capable of increasing users' interest and participation, because they enable users to experience reality via virtual content. These technologies continue to be applied to various fields.

Because augmented reality technology can be implemented even when only a user terminal is present, augmented reality technology is more likely to be able to be applied to various fields, and can be used with respect to educational content, game content, and the like.

### SUMMARY

One or more embodiments include a three-dimensional (3D) content providing system, a 3D content providing method, and a computer-readable recording medium, by which users' interests are caused and users' participation is increased by generating a 3D image from a user-participating 2D image, manufacturing the 3D image as an object or content, and applying the object or content to a new platform.

Additional aspects will be set forth in part in the description which follows and, in part, will be apparent from the description, or may be learned by practice of the presented embodiments.

According to one or more embodiments, a three-dimensional (3D) content providing system includes an imaging unit configured to acquire a two-dimensional (2D) image; an image conversion unit configured to extract a rectangular region that surrounds the 2D image acquired by the imaging unit, and to perform image warping with respect to the extracted rectangular region to thereby generate a 3D image corresponding to the 2D image; and a display unit configured to output the 3D image.

The image conversion unit may detect a plurality of coordinates corresponding to feature points of a 2D image that has undergone the image warping, may generate the 3D image by using the detected coordinates, may extract a color from the 2D image, and may color a location corresponding to the 3D image with the extracted color.

The image conversion unit may acquire the 3D image from a database (DB) that stores the 2D image that has undergone the image warping and a 3D image corresponding to the image-warped 2D image.

The 3D content providing system may further include a content merging unit configured to merge the 3D image with a moving image. The display unit may output merged content obtained from the merging of the 3D image with the moving image.

The 3D content providing system may further include an object extraction unit configured to extract the 3D image generated by the image conversion unit as an individual object. The extracted object may be insertable into a first platform.

According to one or more embodiments, a 3D content providing method is performed by a terminal device comprising an imaging unit and a display unit, and the 3D content providing method includes acquiring a 2D image by using the imaging unit; extracting a rectangular region that surrounds the acquired 2D image, and performing image warping with respect to the extracted rectangular region to thereby generate a 3D image corresponding to the 2D image; and outputting the generated 3D image via the display unit.

The generating of the 3D image may include detecting a plurality of coordinates corresponding to feature points of a 2D image that has undergone the image warping, generating the 3D image by using the detected coordinates, extracting a color from the 2D image, and coloring a location corresponding to the 3D image with the extracted color.

The generating of the 3D image may include acquiring the 3D image from a DB that stores the 2D image that has undergone the image warping and a 3D image corresponding to the image-warped 2D image.

The 3D content providing method may further include merging the 3D image with a moving image. The outputting of the generated 3D image may include outputting merged content obtained from the merging of the 3D image with the moving image.

The 3D content providing method may further include extracting the 3D image generated in the generating of the 3D image, as an individual object; and inserting the extracted object into a first platform.

According to one or more embodiments, a non-transitory computer-readable recording medium has recorded thereon a program for executing the above-described method.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of a three-dimensional (3D) content providing system according to an embodiment of the present invention;

FIG. 2 illustrates a two-dimensional (2D) image acquired by the 3D content providing system of FIG. 1;

FIGS. 3A and 3B illustrate 2D image warping that is performed by the 3D content providing system of FIG. 1;

FIG. 4 illustrates a 3D image generated by the 3D content providing system of FIG. 1;

FIG. 5 is a block diagram of a 3D content providing system according to another embodiment of the present invention;

FIG. 6 is a block diagram of a 3D content providing system according to another embodiment of the present invention;

FIGS. 7A and 7B illustrate merged content generated by the 3D content providing system of FIG. 6;

FIG. 8 is a block diagram of a 3D content providing system according to another embodiment of the present invention;

FIG. 9 illustrates insertion of an object extracted by the 3D content providing system of FIG. 8 into a new platform;

FIG. 10 is a flowchart of a 3D content providing method according to an embodiment of the present invention;

FIG. 11 is a flowchart of a 3D content providing method according to another embodiment of the present invention; and

FIG. 12 is a flowchart of a 3D content providing method according to another embodiment of the present invention.

### DETAILED DESCRIPTION

The attached drawings for illustrating exemplary embodiments of the present invention are referred to in order to gain a sufficient understanding of the present invention, the merits thereof, and the objectives accomplished by the implementation of the present invention. However, this is not intended to limit the inventive concept to particular modes of practice, and it is to be appreciated that all changes, equivalents, and substitutes that do not depart from the spirit and technical scope of the inventive concept are encompassed in the inventive concept. These embodiments are provided so that this disclosure will be thorough and complete, and will fully convey the scope of the inventive concept to one of ordinary skill in the art. In the description of the present invention, certain detailed explanations of the related art are omitted when it is deemed that they may unnecessarily obscure the essence of the present invention.

The terms used in the present specification are merely used to describe particular embodiments, and are not intended to limit the scope of the inventive concept. An expression used in the singular encompasses the expression of the plural, unless it has a clearly different meaning in the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. While the terms including an ordinal number, such as “first”, “second”, etc., may be used to describe various components, such components must not be limited by theses terms. The above terms are used only to distinguish one component from another.

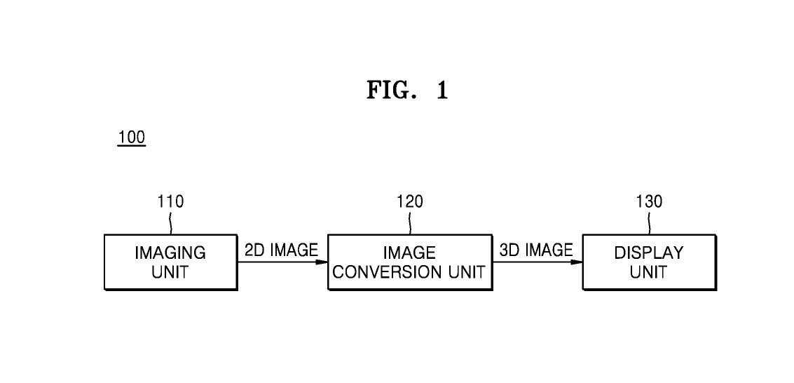

FIG. 1 is a block diagram of a three-dimensional (3D) content providing system 100 according to an embodiment of the present invention.

Referring to FIG. 1, the 3D content providing system 100 includes an imaging unit 110, an image conversion unit 120, and a display unit 130. The imaging unit 110 acquires a two-dimensional (2D) image, and the 2D image may be provided as a user-participating image and may be an image colored by a user.

The image conversion unit 120 extracts a rectangular region that surrounds the 2D image acquired by the imaging unit 110, and performs image warping with respect to the extracted rectangular region, thereby generating a 3D image corresponding to the 2D image.

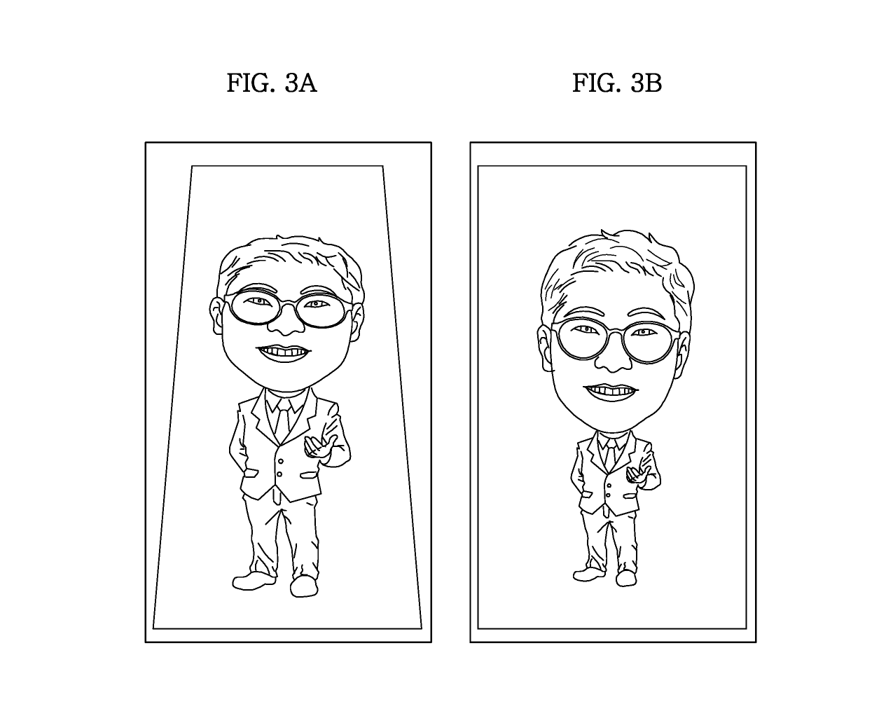

Image warping may be used to correct distortion of a digital image via a manipulation, such as adjustment of a distance between coordinates that constitute an image. The image warping performed by the image conversion unit 120 is used to correct the 2D image captured by the imaging unit 110 into a rectangular image, and will be described in more detail later with reference to FIGS. 3A and 3B.

The image conversion unit 120 may extract a feature point from the 2D image and may generate the 3D image by using the extracted feature point. The 2D image may include a plurality of feature points, and a 3D image corresponding to the coordinates of the plurality of feature points may be previously determined.

The display unit 130 outputs the 3D image generated by the image conversion unit 120.

The acquisition of the 2D image by the imaging unit 110 and the display of the 3D image, as a final result, are sequentially performed, and also in real time.

When the imaging unit 110 heads for the 2D image, the display unit 130 may output the 2D image to the user in real time, and simultaneously the display unit 130 may display the 3D image generated by the image conversion unit 120 by partially overlapping the 2D image.

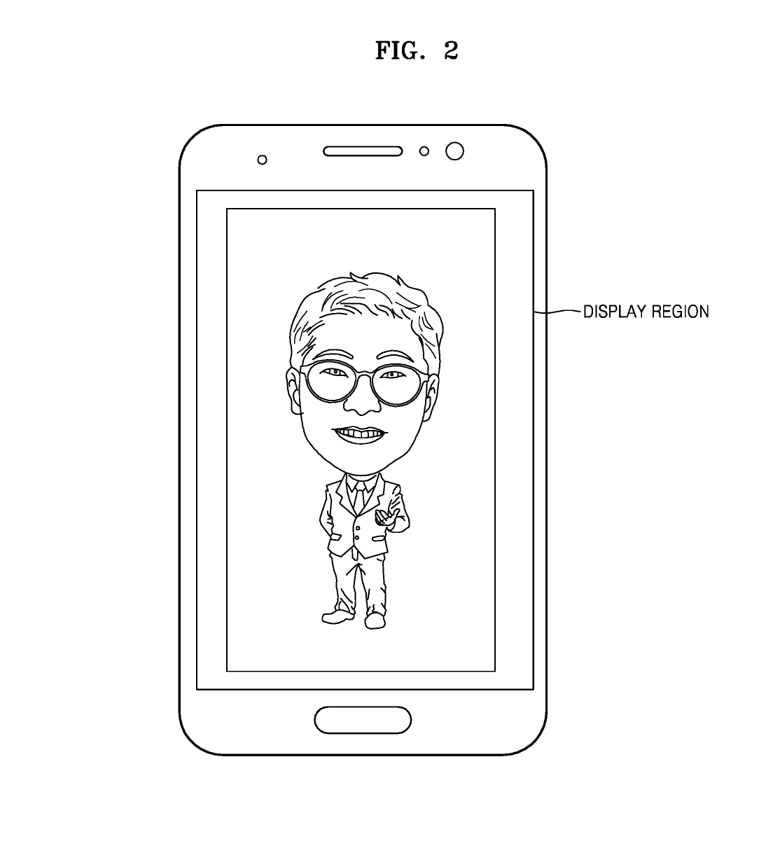

FIG. 2 illustrates a 2D image acquired by the 3D content providing system 100, according to an embodiment of the present invention.

Referring to FIG. 2, the 3D content providing system 100 may be implemented via a terminal device including a camera and a display region. For example, the imaging unit 110 described above with reference to FIG. 1 may be implemented by the camera and the display unit 130 may be implemented by the display region. The image conversion unit 120 may be implemented via an image conversion application installed in the terminal device.

In other words, the terminal device may be understood as a general mobile communication terminal device including a camera and a display panel, and the display panel may include a touch panel.

When a 2D image is acquired by the camera, image conversion including image warping may be performed via the image conversion application installed in the terminal device, and the 2D image and the 3D image generated from the 2D image may be output via the display region.

A screen image illustrated in FIG. 2 shows the 2D image not yet acquired via the camera. When a photographing button (not shown) or an image acquisition button (not shown) displayed on the display region is selected, the 2D image displayed on the display region may be acquired.

The screen image of FIG. 2 may be understood as an image obtained after performing the image conversion application installed in the terminal device. When the photographing button or the image acquisition button is selected, the 2D image may be acquired, and the 3D image may be generated via the image conversion application.

In detail, when the photographing button or the image acquisition button is selected and then the 3D image is generated via the image conversion application, namely, by the image conversion unit 120, the 3D image may be displayed by overlapping the 2D image displayed on the display region, and the 3D image may be displayed relative to the location of the 2D image.

FIGS. 3A and 3B illustrate 2D image warping that is performed by the 3D content providing system 100.

FIG. 3A illustrates a 2D image originally acquired by the imaging unit 110, and FIG. 3B illustrates a 2D image obtained by performing image warping on the 2D image original.

In order for the 3D content providing system 100 to generate a 3D image from a 2D image, a rectangular 2D image needs to be acquired first.

As described above with reference to FIG. 1, in the present invention, image warping is performed to generate a complete 3D image by correcting image distortion that occurs when a 2D image original acquired by the imaging unit 110 is not extracted in a rectangular shape.

Referring to FIG. 3A, the 2D image original is captured in a trapezoidal shape due to an acute angle between a direction in which the imaging unit 110 is oriented and the 2D image.

The image conversion unit 120 may perform image warping with respect to the 2D image original to thereby generate a rectangular 2D image as in FIG. 3B. The image conversion unit 120 may calculate a screen coordinate from the 2D image original acquired by the imaging unit 110 before performing image warping with respect to the 2D image original, and may extract an object region by using the screen coordinate. The screen coordinate denotes the coordinates of points corresponding to four vertexes of the display region, as described above with reference to FIG. 2.

The 2D image that has undergone image warping may have a rectangular frame, and feature points are extracted from the 2D image existing within the rectangular frame. The image conversion unit 120 may detect a plurality of coordinates corresponding to the feature points and may generate the 3D image by using the detected coordinates.

The feature points serve as a basis for designing a 3D image from a 2D image, and thus a 3D image corresponding to the coordinates of the feature points may be previously determined.

The image conversion unit 120 may extract a color from the 2D image and may coat a location corresponding to the 3D image with the extracted color. As described above with reference to FIG. 1, the 2D image may be a user-participating image and thus the user may color a 2D image including only a rough sketch with a desired color, and the image conversion unit 120 may extract the color used by the user from the 2D image original acquired by the imaging unit 110.

The image conversion unit 120 may coat a color assigned by the user on the 3D image by performing texture mapping with respect to the extracted color and the 2D image having undergone image warping.

During the texture mapping, the image conversion unit 120 may further perform an operation of correcting a color corruption caused by a shadow or the like that may be generated during the image acquisition by the imaging unit 110.

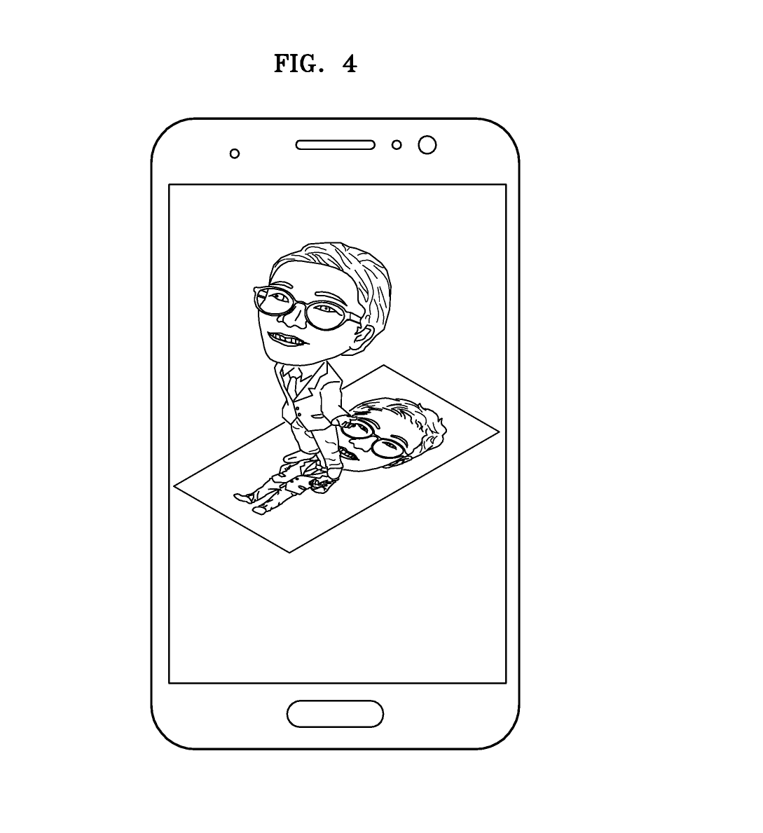

FIG. 4 illustrates a 3D image generated by the 3D content providing system 100.

Referring to FIG. 4, a 3D image is generated from the 2D image described above with reference to FIGS. 2 and 3. As described above with reference to the preceding drawings, the image conversion unit 120 generates the 3D image from the 2D image original acquired by the imaging unit 110, extracts the screen coordinate and an object corresponding to the 2D image, and then converts the object into a shape having a rectangular frame that is transformable to the 3D image, via image warping.

The image conversion unit 120 extracts a plurality of feature points from the 2D image that has undergone image warping, and generates the 3D image by using the plurality of extracted feature points.

The 3D image generated by the image conversion unit 120 may be output via the display unit 130, and the 3D image may be displayed via a screen image acquired by the imaging unit 110 and may be displayed by overlapping the 2D image. Accordingly, the 3D content providing system 100 may provide an augmented reality effect.

As described above with reference to FIG. 2, the display unit 130 may include a display panel including a touch panel, and the 3D image output via the display unit 130 may be zoomed in, zoomed out, and/or rotated by a touch of a user.

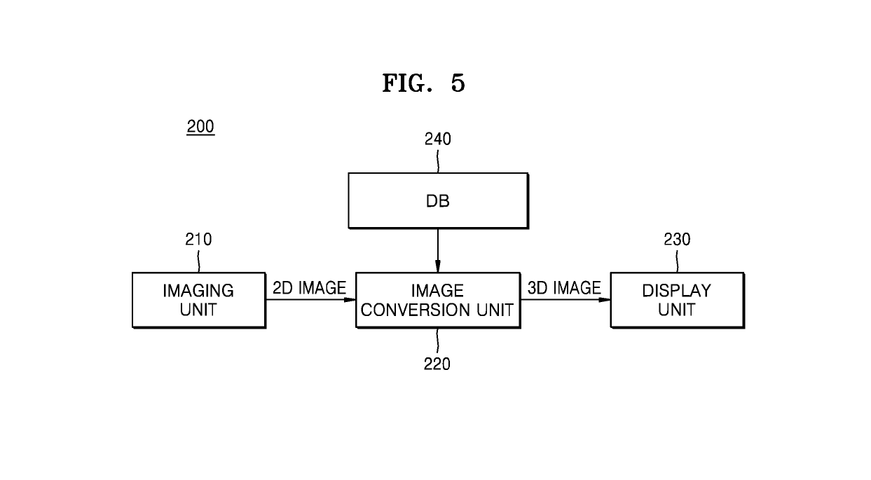

FIG. 5 is a block diagram of a 3D content providing system 200 according to another embodiment of the present invention.

Referring to FIG. 5, the 3D content providing system 200 includes an imaging unit 210, an image conversion unit 220, a display unit 230, and a database (DB) 240. The imaging unit 210, the image conversion unit 220, and the display unit 230 perform substantially the same functions as the imaging unit 110, the image conversion unit 120, and the display unit 130 of FIG. 1, and thus repeated descriptions thereof will not be given.

The DB 240 stores a 3D image corresponding to a 2D image that has undergone image warping. The image conversion unit 220 extracts a plurality of feature points from the image-warped 2D image and searches the DB 240 for the 3D image by using the plurality of feature points, and the display unit 230 displays the 3D image found in the DB 240.

The DB 240 may be understood as including 2D image information including coordinate information of the feature points and a 3D image corresponding to the 2D image information. In other words, coordinate information of the plurality of feature points included in the 2D image may be previously stored, and the image conversion unit 220 may search for the 3D image by comparing the 2D image acquired by the imaging unit 210 with the 2D image information stored in the DB 240 by using an image tracking algorithm with respect to the coordinate information of the plurality of feature points.

The image conversion unit 220 may perform conversion into a screen coordinate system via a camera coordinate system of the 2D image acquired by the imaging unit 210. At this time, the image conversion unit 220 may calculate a homographic matrix by using a projection matrix.

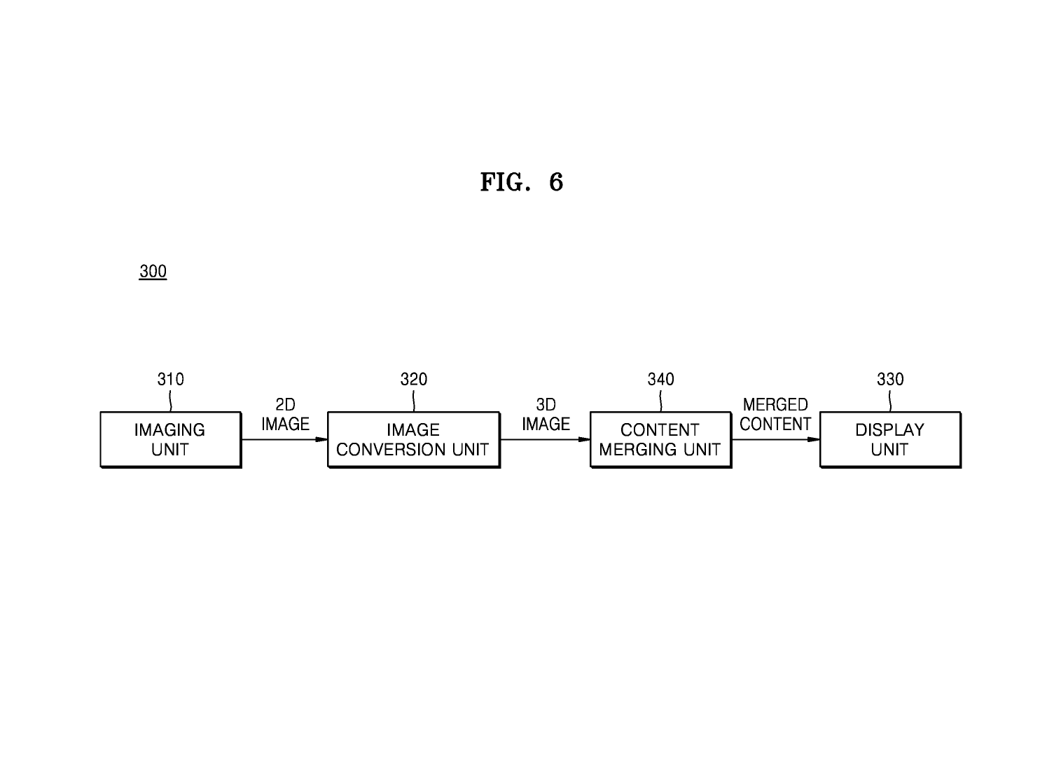

FIG. 6 is a block diagram of a 3D content providing system 300 according to another embodiment of the present invention.

Referring to FIG. 6, the 3D content providing system 300 includes an imaging unit 310, an image conversion unit 320, a display unit 330, and a content merging unit 340.

The imaging unit 310, the image conversion unit 320, and the display unit 330 perform substantially the same functions as the imaging units 110 and 210, the image conversion units 120 and 220, and the display units 130 and 230 of FIGS. 1 and 2, and thus repeated descriptions thereof will not be given.

The content merging unit 340 merges a 3D image generated by the image conversion unit 320 with a moving image. The moving image may be previously determined in correspondence with the 3D image, or the moving image may be designated by a user.

The content merging performed by the content merging unit 340 may be understood as generating the 3D image and the moving image, each corresponding to individual content, into an item of content.

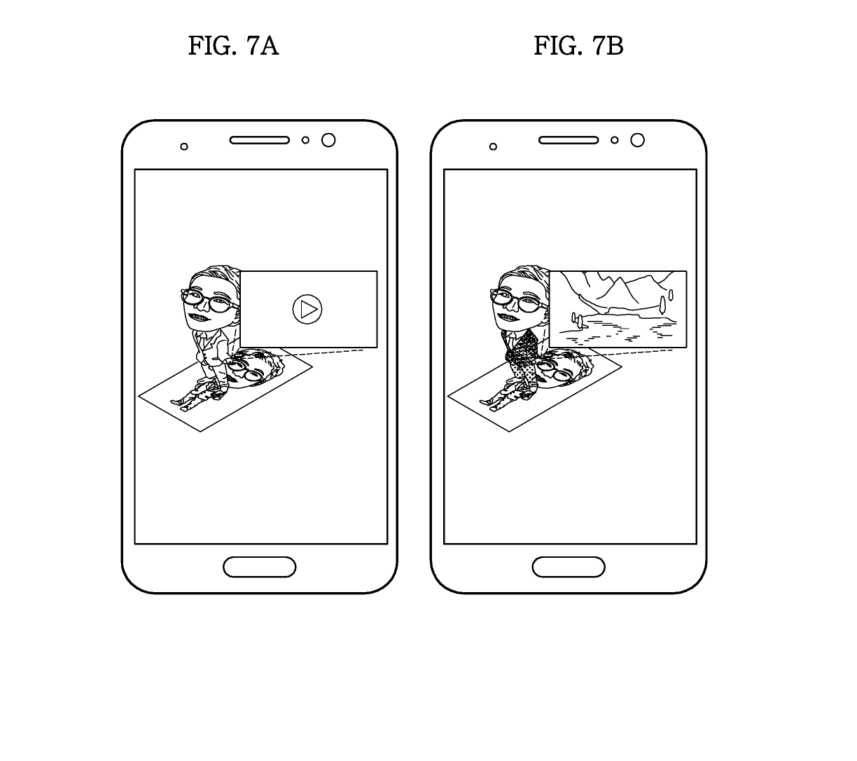

FIGS. 7A and 7B illustrate merged content generated by the 3D content providing system 300.

Referring to FIGS. 7A and 7B, merged content is obtained by the content merging unit 340 of FIG. 6. FIG. 7A illustrates a screen image captured by the imaging unit 310. The screen image includes a 2D image, a 3D image generated from the 2D image and displayed by overlapping the 2D image, and a moving image.

The 3D image and the moving image may be merged by the content merging unit 340 and may be controlled as a single item of content. For example, the locations of the 3D image and the moving image may be fixed as shown in FIG. 7A, and the 3D image and the moving image may be zoomed in, zoomed out, or rotated by a touch of a user.

When the user selects a playback button of the moving image, the moving image is reproduced, and thus the moving image appears as if it is being introduced by a person corresponding to the 3D image.

FIG. 7B illustrates merged content obtained by the content merging unit 340. In contrast with the 3D image of FIG. 7A, the 3D image of FIG. 7B has a color assigned by a user.

When the 2D image is assigned no colors, the image conversion unit 320 may assign a preset color to the 3D image. When the 2D image is assigned a certain color as shown in FIG. 7B, the image conversion unit 320 may extract the color assigned by the user and may color the 3D image with the extracted color, and may display the 3D image as shown in FIG. 7B.

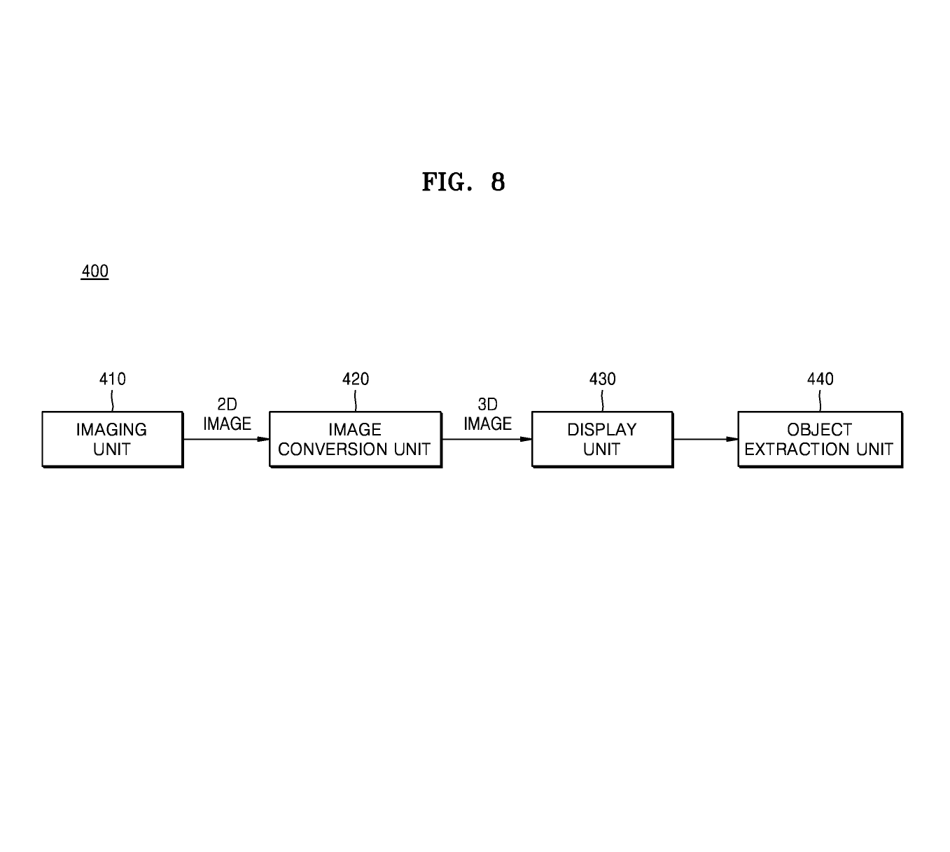

FIG. 8 is a block diagram of a 3D content providing system 400 according to another embodiment of the present invention.

Referring to FIG. 8, the 3D content providing system 400 includes an imaging unit 410, an image conversion unit 420, a display unit 430, and an object extraction unit 440.

The imaging unit 410, the image conversion unit 420, and the display unit 430 perform substantially the same functions as the imaging units 110, 210, and 310, the image conversion units 120, 220, and 320, and the display units 130, 230, and 330 of FIGS. 1, 5, and 6, and thus repeated descriptions thereof will not be given.

The object extraction unit 440 extracts a 3D image generated by the image conversion unit 420 as an individual object, and the extracted object is insertable into a first platform. For example, the 3D image that is output via the display unit 430 may be stored as an individual object in a terminal device by a user, and the stored object may be inserted into a platform, such as a game, educational software, or a visual novel platform.

When the 3D image that may be generated by coloring a user-participating 2D image with a color desired by a user is inserted as an individual object into a new platform, since the user is able to apply his or her manufactured 3D content to various platforms, the 3D content providing system 400 may improve participation of the user via such a structure as in FIG. 8.

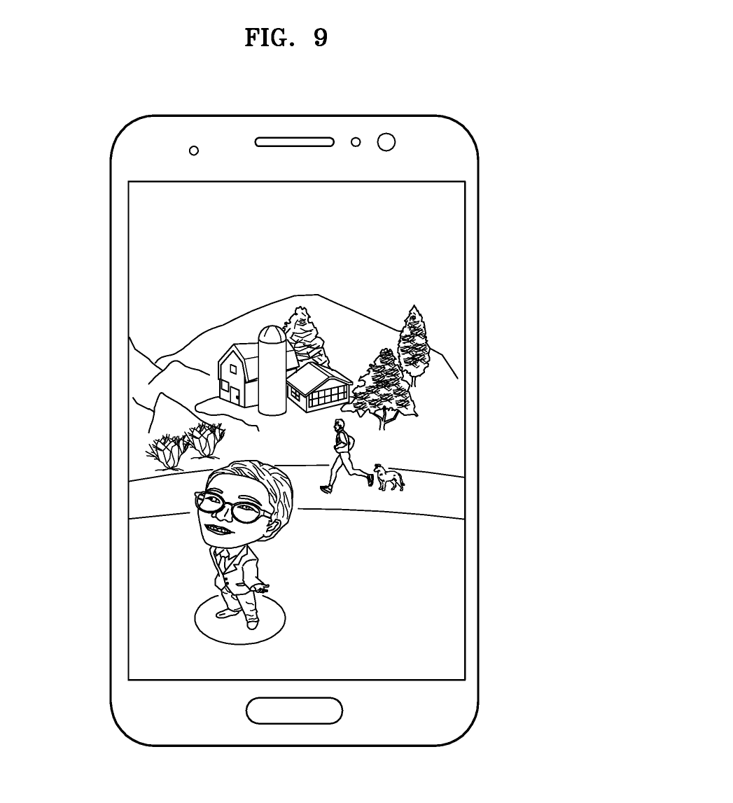

FIG. 9 illustrates insertion of an object extracted by the 3D content providing system 400 into a new platform.

Referring to FIG. 9, the object extracted by the object extraction unit 440 is inserted into a new platform. The 3D image generated by the image conversion unit 420 may be extracted as an individual object and may be inserted into the platform in the form of new content.

When the platform is a game, the 3D content may become a character of the game by maintaining the shape and the color of the 3D image generated from a user-participating image.

Thus, like the characters basically provided by the game, a control operation applied to the characters may be equally applied to the 3D content, and this structure heightens a user's interest in the game and motivation to continuously generate new 3D images.

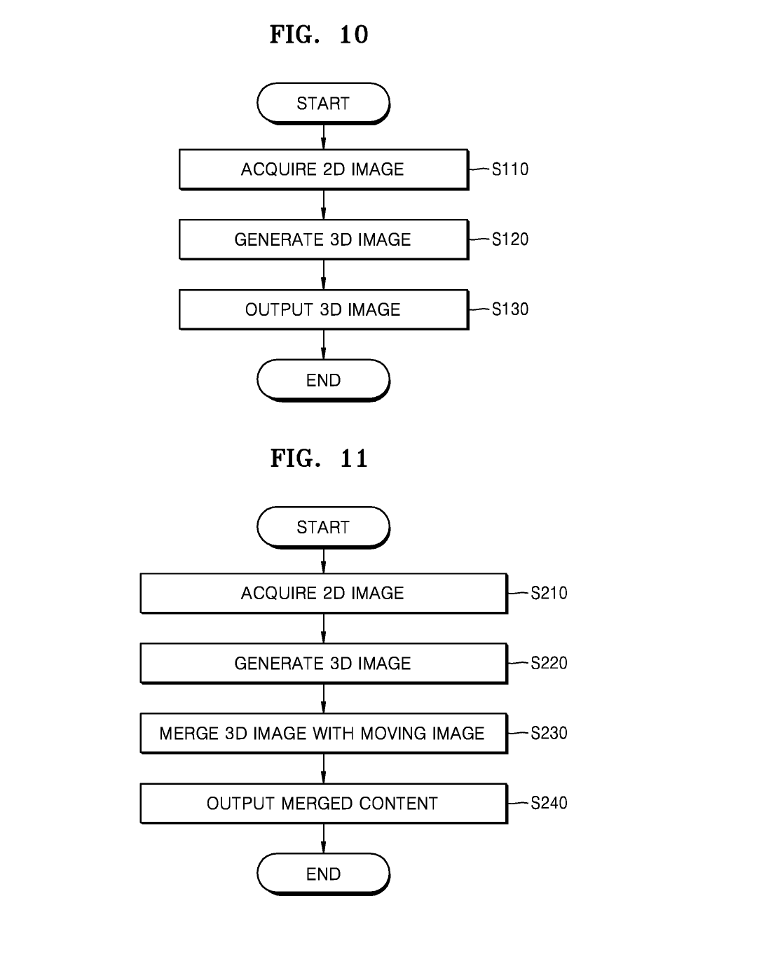

FIG. 10 is a flowchart of a 3D content providing method according to an embodiment of the present invention.

Referring to FIG. 10, the 3D content providing method includes a 2D image acquisition operation S110, a 3D image generation operation S120, and a 3D image outputting operation S130.

The operations of the 3D content providing method may be performed by a terminal device including an imaging unit and a display unit. In the 2D image acquisition operation S110, a 2D image may be acquired using the imaging unit. The 2D image may be provided as a user-participating image and may be an image colored by a user.

In the 3D image generation operation S120, a rectangular region that surrounds the 2D image is extracted and undergoes image warping, thereby generating a 3D image corresponding to the 2D image.

Image warping may be used to correct distortion of a digital image via a manipulation, such as adjustment of a distance between coordinates that constitute an image. The image warping performed in the 3D image generation operation S120 is used to correct the 2D image captured in the 2D image acquisition operation S110 into a rectangular image.

In the 3D image generation operation S120, a feature point may be extracted from the 2D image, and the 3D image may be generated by using the extracted feature point. The 2D image may include a plurality of feature points, and a 3D image corresponding to the coordinates of the plurality of feature points may be previously determined.

In the 3D image generation operation S120, an image conversion application installed in the terminal device may be performed.

In other words, the terminal device may be understood as a general mobile communication terminal device including a camera and a display panel, and the display panel may include a touch panel.

In the 3D image generation operation S120, a plurality of coordinates corresponding to the feature points of the 2D image having undergone image warping may be detected, and the 3D image is generated using the plurality of coordinates. When the 3D image is generated, a color may be extracted from the 2D image and may be coated on a location corresponding to the 3D image.

In the 3D image generation operation S120, the 3D image may be acquired from a DB that stores the 2D image having undergone image warping and the 3D image corresponding to the 2D image.

In the 3D image outputting operation S130, the 3D image is displayed via the display unit. The acquisition of the 2D image in the 3D image generation operation S120 and the display of the 3D image, as a final result, in operation S130 are sequentially performed and also performed in real time.

When the imaging unit heads for the 2D image, the 2D image may be output to the user in real time via the display unit, and simultaneously the 3D image generated in the 3D image generation operation S120 may be displayed by partially overlapping the 2D image in the 3D image outputting operation S130.

When a 2D image is acquired by the camera, image conversion including image warping may be performed via the image conversion application installed in the terminal device, and the 2D image and the 3D image generated from the 2D image may be output via the display unit.

FIG. 11 is a flowchart of a 3D content providing method according to another embodiment of the present invention.

Referring to FIG. 11, the 3D content providing method includes a 2D image acquisition operation S210, a 3D image generation operation S220, a moving image merging operation S230, and a merged content outputting operation S240. Since the 2D image acquisition operation S210 and the 3D image generation operation S220 are substantially the same as the 2D image acquisition operation S110 and the 3D image generation operation S120 of FIG. 10, redundant descriptions thereof will not be given.

In the moving image merging operation S230, a 3D image generated in the 3D image generation operation S220 is merged with a moving image. In the merged content outputting operation S240, merged content obtained by merging the 3D image with the moving image is output.

The moving image may be previously determined in correspondence with the 3D image, or the moving image may be designated by a user.

The content merging performed in the moving image merging operation S230 may be understood as generating the 3D image and the moving image, each corresponding to individual content, into an item of content.

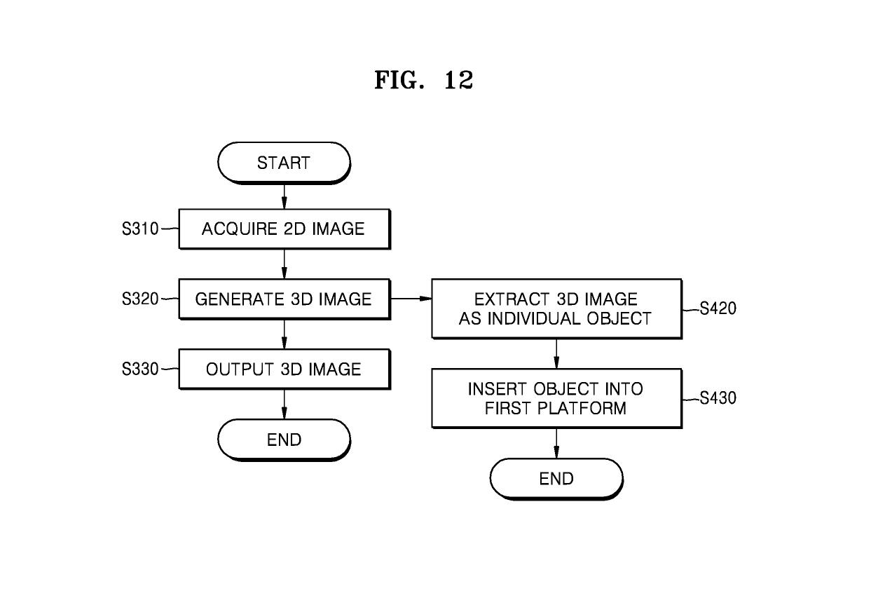

FIG. 12 is a flowchart of a 3D content providing method according to another embodiment of the present invention.

Referring to FIG. 12, the 3D content providing method includes a 2D image acquisition operation S310, a 3D image generation operation S320, a 3D image outputting operation S330, an operation S420 of extracting a 3D image as an individual object, and an operation S430 of inserting the object into a first platform.

Since the 2D image acquisition operation S310, the 3D image generation operation S320, and the 3D image outputting operation S330 are substantially the same as the 2D image acquisition operation S110, the 3D image generation operation S120, and the 3D image outputting operation S130 of FIG. 10, redundant descriptions thereof will not be given.

In operation S420, the 3D image generated in operation S320 is extracted as an individual object. The extracted object is generated to be insertable into the first platform. In operation S430, the extracted object is inserted into the first platform.

For example, the 3D image that is output in operation S330 may be stored as an individual object in a terminal device by a user, and the stored object may be inserted into a platform, such as a game, educational software, or a visual novel platform.

When the 3D image that may be generated by coloring a user-participating 2D image with a color desired by a user is inserted as an individual object into a new platform, since the user is able to apply his or her manufactured 3D content to various platforms, the 3D content providing method of FIG. 12 may improve participation of the user.

A 3D content providing system, a 3D content providing method, and a non-transitory computer-readable recording medium according to one or more embodiments of the present invention induce users' interest and increase users' participation by generating a 3D image from a user-participating 2D image, manufacturing the 3D image as an object or content, and applying the object or content to a new platform.

The present invention can be embodied as computer readable codes on a non-transitory computer readable recording medium. The non-transitory computer readable recording medium is any type of recording device that stores data which can thereafter be read by a computer system.

Examples of the non-transitory computer-readable recording medium include ROM, RAM, CD-ROMs, magnetic tapes, floppy discs, and optical data storage media.

The non-transitory computer readable recording medium can also be distributed over network coupled computer systems so that the computer readable code is stored and executed in a distributive manner. Also, functional programs, codes, and code segments for accomplishing the inventive concept can be easily construed by programmers skilled in the art to which the inventive concept pertains.

The steps of all methods described herein can be performed in any suitable order unless otherwise indicated herein or otherwise clearly contradicted by context. Embodiments of the present invention are not limited to the described order of the operations.

The use of any and all examples, or exemplary language (e.g., “such as”) provided herein, is intended merely to better illuminate the inventive concept and does not pose a limitation on the scope of the inventive concept unless otherwise claimed. Numerous modifications and adaptations will be readily apparent to one of ordinary skill in the art without departing from the spirit and scope.

Therefore, the scope of the present invention is defined not by the detailed description but by the appended claims, and all differences within the scope will be construed as being included in the present invention.

What is claimed is:

1. A three-dimensional (3D) content providing system comprising:
an imaging unit configured to acquire a two-dimensional (2D) image;
an image conversion unit configured to extract a rectangular region that surrounds the 2D image acquired by the imaging unit, and to perform image warping with respect to the extracted rectangular region to thereby generate a 3D image corresponding to the 2D image; and
a display unit configured to output the 3D image.

2. The 3D content providing system of claim 1, wherein
the image conversion unit is configured to detect a plurality of coordinates corresponding to feature points of a 2D image that has undergone the image warping and to generate the 3D image by using the detected coordinates, and
is configured to extract a color from the 2D image and to color a location corresponding to the 3D image with the extracted color.

3. The 3D content providing system of claim 1, wherein the image conversion unit is configured to acquire the 3D image from a database (DB) that stores the 2D image that has undergone the image warping and a 3D image corresponding to the image-warped 2D image.

4. The 3D content providing system of claim 1, further comprising a content merging unit configured to merge the 3D image with a moving image,
wherein the display unit is configured to output merged content obtained from the merging of the 3D image with the moving image.

5. The 3D content providing system of claim 1, further comprising an object extraction unit configured to extract the 3D image generated by the image conversion unit as an individual object,
wherein the extracted object is insertable into a first platform.

6. A 3D content providing method performed by a terminal device comprising an imaging unit and a display unit, the 3D content providing method comprising:
acquiring a 2D image by using the imaging unit;
extracting a rectangular region that surrounds the acquired 2D image, and performing image warping with respect to the extracted rectangular region to thereby generate a 3D image corresponding to the 2D image; and
outputting the generated 3D image via the display unit.

7. The 3D content providing method of claim 6, wherein
the generating of the 3D image comprises detecting a plurality of coordinates corresponding to feature points of a 2D image that has undergone the image warping and generating the 3D image by using the detected coordinates, and
extracting a color from the 2D image and coloring a location corresponding to the 3D image with the extracted color.

8. The 3D content providing method of claim 7, wherein the generating of the 3D image comprises acquiring the 3D image from a DB that stores the 2D image that has undergone the image warping and a 3D image corresponding to the image-warped 2D image.

9. The 3D content providing method of claim 7, further comprising merging the 3D image with a moving image,
wherein the outputting of the generated 3D image comprises outputting merged content obtained from the merging of the 3D image with the moving image.

10. The 3D content providing method of claim 7, further comprising:
extracting the 3D image generated in the generating of the 3D image, as an individual object; and
inserting the extracted object into a first platform.

11. A non-transitory computer-readable recording medium having recorded thereon a program for executing the method of claim 6.

12. A non-transitory computer-readable recording medium having recorded thereon a program for executing the method of claim 7.

13. A non-transitory computer-readable recording medium having recorded thereon a program for executing the method of claim 8.

14. A non-transitory computer-readable recording medium having recorded thereon a program for executing the method of claim 9.

15. A non-transitory computer-readable recording medium having recorded thereon a program for executing the method of claim 10.
